(19) United States
(12) Patent Application Publication
(10) Pub. No.: US 2003/0207005 A1
(43) Pub. Date: Nov. 6, 2003

(54) Method and system for retaining high viscosity of fluid food product with the reduction of gums

(76) Inventors: John M. Martin, Blairstown, NJ (US); Jeannette Dido, Hoboken, NJ (US); Art Paradissis, Easton, PA (US); Gary Skene, Meadowvale (CA); Timothy Parsons, Burbank, CA (US)

Correspondence Address: FULBRIGHT & JAWORSKI, LLP, 1301 MCKINNEY, SUITE 5100, HOUSTON, TX, 77010-3095, US

(21) Appl. No.: 10/138,018

(22) Filed: May 3, 2002

(51) Int. Cl. C12C 3/04

(52) U.S. Cl. 426/392

(57) ABSTRACT

The present invention is drawn the a method and system for a single step filling process for a fluid food product. More particularly, the method and system eliminates the necessity of addition of large amounts of gums.

### FIELD OF INVENTION

The present invention is related to a method and system for retaining high viscosity of fluid food products during the processing step. More particularly, the present invention significantly reduces the addition of gums for a single-step filling process.

### BACKGROUND OF THE INVENTION

Food products that contain a liquid component, such as gravy, and a solid or semi-solid component, such as a meat chunk, are usually manufactured and packaged using cumbersome and inefficient processes unsuited for single-step mass production. However, gravy and chunk products can easily be processed using a two step filling process in which the liquid and the solid/semi-solid chunks are put into the container by separate fillers. The suspension of solid/semi-solid foods are suspended as correct ratios of the two components in the container after filling. The two step process is an unsuitable process for high-speed filling processes.

A single-step process has been proposed, however, the single step process requires addition of large amounts of gums, which are not nutritionally ideal for the consumer. Gums are typically large polysaccharides. Most consumers are not able to digest these polysaccharides due to a decrease or lack of enzymes in the intestinal cells of the lumen. Maldigestion of these polysaccharides create an osmotic effect in the lumen of the intestines. This osmotic effect, which pulls excess water into the intestinal lumen, results in watery stool or diarrhea.

The present invention is drawn to a method and system of a single step filling process without the necessity of the addition of large amounts of gums. The reduction of gums will also assist in increased quality of the stool for the consumer.

### BRIEF SUMMARY OF THE INVENTION

The present invention is drawn to a method and system for a single step filling process for a food product that contains a liquid component and a semi-solid or solid component.

One specific embodiment of the present invention is a method for filling a container with a final food product. The method includes the steps of providing to a filling device an intermediate food product. The next step is dispensing the intermediate food product into the container. Additional liquid is added to the intermediate food product in the container and the container is sealed. The additional liquid returns the intermediate food product to a recipe acceptable to the consumer from which it was altered for the filling process.

Another specific embodiment is a system for filling a container with a final food product. The system includes a filling device. The filling device is capable of dispensing an intermediate food product into the container and adding additional liquid to the intermediate food product in the container to suspend the intermediate food product in the liquid.

The foregoing has outlined rather broadly the features and technical advantages of the present invention in order that the following detailed description of the invention may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description.

### DETAILED DESCRIPTION OF THE INVENTION

It is readily apparent to one skilled in the art that various embodiments and modifications can be made to the invention disclosed in this Application without departing from the scope and spirit of the invention.

As used herein, the use of the word “a” or “an” when used in conjunction with the term “comprising” in the sentences and/or the specification can mean “one,” but it is also consistent with the meaning of “one or more,” “at least one,” and “one or more than one.”

An embodiment of the present invention is a method for filling a container with a final food product. The method includes the steps of providing to a filling device an intermediate food product; dispensing the intermediate food product into the container; adding additional liquid to the intermediate food product in the container; and sealing the container. The additional liquid returns the intermediate food product to a recipe acceptable to the consumer from which it was altered for the filling process. Yet further, it is envisioned that the container includes, but is not limited to a can, bag or bowl. In specific embodiments, the dispensing step and adding step are preformed simultaneously. Thus, when the dispensing and adding steps are performed simultaneously, the present invention is a single-step process.

The final food product of the present invention is a product that contains two components, a liquid component and a semi-solid or solid component. It is envisioned that the final food product is a homogenous mixture of the liquid and solid or semi-solid food product. An example of the food product is a meat-in-gravy product, which may include, but is not limited to meatballs-in-gravy, meat chunks in a sauce, etc. Another example may include soup, such has broth with vegetables, pasta, rice or meat. The food product may be a pet food product for consumption by companion animals. Yet further, the food product may be a product for human consumption.

As used herein, the semi-solid or solid component may be referred to as a “chunk”. The chunk may typically be a piece of meat or meat by-products. The density of a chunk can be in the range of 1.04 to 1.1 g/ml and variations in between, thereof. Typical volumes of the chunks can include, but are not limited to the 75 m³, 97.5 m³, 162.5 m³, 1263.5 m³, 1093.75 m³, 450 m³, 770 m³, 2527 m³ and 3249 m³. Preferable volumes of chunks include 162.5 m³, 1263.5 m³, 1093.75 m³, 450 m³, and 770 m³,and any variation in between, thereof. Thus, one of skill in the art realizes that the dimension of the chunk may be any dimension such that the volume is within the range of volumes provided herein.

Included within the term meat are those meat-derived ingredients defined as “meat” and “meat by-products” by the current Definitions of Feed Ingredients published by the Association of American Feed Control Officials, Incorporated. As defined, the term “meat” includes not only the flesh of cattle, swine, sheep and goats, but also other mammals, poultry and fish. The term “meat by-products” is defined to include non-rendered parts of the carcass of slaughtered animals, poultry and the like. The remainder of the meat chunk generally comprises grains, fibrous materials, vitamins, and the like. Some of these are effective binding agents for the meat chunk as well. Wheat flour, dry blood plasma and dried egg are effective binding agents for the meat derived ingredients from which the meat chunks are manufactured. Vitamins and minerals can also be added.

In addition to these ingredients, various minor ingredients such as nutritional supplements, salts, coloring agents, and the like, are also included in the meat chunk formulation to provide nutritional balance and palatability.

The liquid component or gravy component is prepared for canning with the meat pieces. The gravy component typically comprises water and thickening agents. It is known that thickeners commonly employed in the gravy component of a meat chunk and gravy diet for pets are responsible for loose stools or diarrhea usually observed in these animals, when fed a diet principally or solely of meat chunk and gravy. These thickeners are chemically modified starch(es), gum(s) and mixtures thereof. Examples of chemically modified starches include starches from corn, wheat, rice, potato, tapioca and the like which are modified by any or a mixture of acylation such as acetylation, cross-linking from groups such as phosphate, hydroxyalkyl such as hydroxypropyl. Examples of gums include xanthan, guar, locust bean, carboxymethylcellulose, and the like. It may be desirable not to use any of these thickening agents. However, any amount of these thickening agents, which does not effect the quality of stool production, is acceptable and can be employed. Generally, less than about 0.2 wt % of the diet of these thickeners can be present without adversely effecting the quality of stool.

Other ingredients, which may be included in the gravy component, are soluble carbohydrates such as maltodextrin, sucrose and corn syrup, as well as also salts, color, flavors and emulsifiers such as lecithin.

In the present invention, less water is added to the food product at the onset of processing. For example, 5% up to 35% of water is withheld from the food product. More preferably, 10% up to 30% of water is withheld from the intermediate food product. This percentage of water reduction corresponds to a ratio of 53:47 up to 60:40 chunk:gravy ratio. One skilled in the art realizes that a reduction in water at the onset of processing results in a higher viscosity of the food product. A viscosity of at least 120 centipoise helps to continuously transport the food product during processing. Yet further, it is more preferable to retain a viscosity of 150-250 centipoise. If the food product is to set idle for a period of time, then it is preferable that the viscosity be greater than 200 centipoise and more preferably 500-600 centipoise. A higher viscosity during an idle time period reduces separation of the food product. The intermediate food product is diluted to a 50:50 ratio by the filling device. The addition of liquid by the filling device alters the viscosity of the liquid component to the standard range of 50-75 centipoise, which is the viscosity of the final food product.

The viscosity of the present invention allows the food product to be transported to the filling device and dispensed into the container. During dispension of the food product, liquid, such as water, is also added to the container. The amount of liquid that is added to the intermediate food product is the amount that was withheld during the processing step. Thus, the addition of water produces a final food product that has the appropriate viscosity for gravy that is consumable by the animal (companion animal or human), which is 50-75 centipoise. Once the liquid or water is added to the container, the container is sealed and sterilized using standard sterilization procedures well known and used by those in the packaging industry.

The single step filling process of the present invention eliminates the need to prepare separately the gravy and chunks and then mix the two components at the last step of processing. Yet further, this single step filling process also significantly reduces the need to add excess amounts of gums to the food product to keep the viscosity of the gravy at a level that it can be processed with the chunks. In fact, it maybe preferable that the food product be “essentially free” of gums. As used herein, “essentially free” refers to no addition of gums or addition of any amount of gums which does not promote the production of stool quality which is unacceptable from the concept of formed versus watery can be employed. Thus, an amount of germs that result in formed stool production can be used and is considered “essentially free” of germs.

The filling device is a nozzle that contains an outlet for the food product and an outlet for liquid. The food outlet and liquid outlet are not limited to dimensions in the nozzle nor are they limited to location on the nozzle. One such example of a nozzle that may be used in the present invention is the nozzle described in U.S. Pat. No. 3,777,447, which is incorporated herein by reference. It is envisioned that any nozzle that is capable of adding food and liquid can be used in the present invention.

The advantage of using a nozzle that contains an outlet for the food product and an outlet for a liquid is that the nozzle or filling device is capable of dispensing the food product and adding additional liquid simultaneously or consecutively to the dispensed food product. The additional liquid returns the food product to a recipe acceptable to the consumer from which it was altered for the filling process.

Another specific embodiment is a system for filling a container with a food product. The system includes a filling device, which is capable of dispensing a food product into the container and adding additional liquid to the food product in the container to bring the recipe to one that is acceptable to the consumer.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for filling a container with a final food product comprising the steps of:
providing to a filling device an intermediate food product;
dispensing the intermediate food product into the container;
adding additional liquid to the intermediate food product in the container, wherein addition of the liquid results in a final food product; and
sealing the container.

2. The method of claim 1, wherein the final food product comprises a liquid component and a solid or semi-solid component.

3. The method of claim 2, wherein the final food product is a homogeneous food product.

4. The method of claim 1, wherein the filling device is capable of performing the dispensing step and the adding step simultaneously.

5. The method of claim 1, wherein the container is a bag, can or bowl.

6. The method of claim 1, wherein the final food product is pet food.

7. The method of claim 5, wherein the final food product is a meat-in-gravy product.

8. The method of claim 1, wherein the final food product is essentially free of gums.

9. The method of claim 1, wherein the final food product results in acceptable stool quality for the consumer.

10. A system for filling a container with a final food product comprising:
a filling device, wherein the filling device is capable of dispensing an intermediate food product into the container and adding additional liquid to the intermediate food product in the container, wherein the additional liquid results in a final food product.

11. The system of claim 1, wherein the final food product comprises a liquid component and a solid or semi-solid component.

12. The system of claim 11, wherein the final food product is a homogeneous food product.

13. The system of claim 7, wherein the container is a bag, can or bowl.

14. The system of claim 7, wherein the final food product is pet food.

15. The system of claim 10, wherein the pet food is a meat-in-gravy product.

16. The system of claim 1, wherein the final food product is essentially free of gums.

17. The system of claim 1, wherein the final food product results in acceptable stool quality for the consumer.
